(19) United States
(12) Patent Application Publication
(10) Pub. No.: US 2024/0279376 A1
(43) Pub. Date: Aug. 22, 2024

(54) RESIN COMPOSITION, RESIN COMPOSITION PRODUCTION METHOD, AND ELECTROCHEMICAL DEVICE

(71) Applicant: National Institutes for Quantum Science and Technology, Chiba (JP)

(72) Inventors: Kimio YOSHIMURA, Gunma (JP); Ahmed Mohamed Ahmed MAHMOUD, Yamanashi (JP); Hwan-Chul YU, Incheon Metropolitan City (KR); Yue ZHAO, Gunma (JP); Akihiro HIROKI, Gunma (JP); Yasunari MAEKAWA, Gunma (JP)

(73) Assignee: National Institutes for Quantum Science and Technology, Chiba (JP)

(21) Appl. No.: 18/563,918

(22) PCT Filed: Mar. 15, 2022
(86) PCT No.: PCT/JP2022/011700

§ 371 Date: Nov. 24, 2023

(30) Foreign Application Priority Data
May 26, 2021 (JP) 2021-088830

(51) Int. Cl. C08F 255/02; C08J 5/22; H01M 8/10; H01M 8/1004; H01M 8/1039; H01M 12/02

(52) U.S. Cl. CPC C08F 255/02; C08J 5/2293; H01M 8/1004; H01M 8/1039; H01M 12/02; C08J 2351/06; H01M 2008/1095; H01M 2300/0082

(57) ABSTRACT

Objective of the present invention is to provide a resin composition having excellent alkaline resistance and a production method of this resin composition. Object of the present invention is to provide an electrochemical device that uses the above-described resin composition and allows improvement of an output power and durability. In order to solve the above-described problem, the resin composition including a structural unit represented by the following formula (1), a resin composition production method thereof, and an electrochemical device using the resin composition,

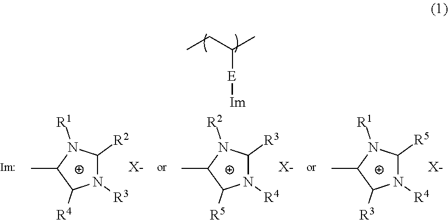

(In the formula, E is a spacer, and represents a benzene ring, a benzene derivative in which at least one atom is substituted with a hydrocarbon group having 1 to 6 carbon atoms, or a carbon chain having at least 2 carbon atoms and optionally including a heteroatom, Im represents an ion conductive group including an imidazole ring, R¹ to R⁵ each independently represent a carbon chain having 1 to 10 carbon atoms and including hydrogen, halogen or a heteroatom, X⁻ represents an anion).

### TECHNICAL FIELD

The present invention relates to a resin composition and a resin composition production method. The present invention relates to an electrochemical device that uses the resin composition as a material for an electrolyte layer and/or an electrode.

### BACKGROUND ART

Generally, it is widely practiced to perform design related to a structural unit of a resin composition and impart desired functions to the resin composition. It is widely practiced to utilize the resin composition having functionality as materials related to various apparatuses (devices).

One example of the apparatus utilizing the resin composition having functionality includes an electrochemical device that converts electric energy and chemical energy. A specific example related to utilization of the resin composition having functionality includes utilizing it as one of materials related to an electrolyte layer (an electrolyte membrane) and an electrode in the electrochemical device.

A Fuel cell and a metal-air battery are known as one of such electrochemical devices. The fuel cell and the metal-air battery use air (oxygen) as an active material on a positive electrode side to convert the energy associated with a chemical reaction with the active material (fuel, metal, or the like) on a negative electrode side into the electric energy, and thus, have an advantage of having higher energy conversion efficiency. Among them, in particular, a solid polymer fuel cell can achieve high output power even with a small size because of using a highly active catalyst, in addition to having low operation temperatures and low resistance of the electrolyte, and is expected to be put into practical use at an early stage.

For example, a proton conductive fuel cell using hydrogen as a fuel is so high in power generation efficiency to become a promising solution to the exhaustion of fossil fuel and can significantly reduce emission of carbon dioxide to become means for deterring global warming, and thus, the development of the proton conductive fuel cell is desired as a power source for domestic cogeneration and automobiles.

In recent years, an anion conductive fuel cell using non-platinum that can use methanol and hydrazine hydrate as a fuel besides hydrogen and has been reported to have three times higher output power than the proton conductive fuel cell has been focused. As for the anion conductive fuel cell, the application to power supplies for disaster countermeasures such as fuel cell vehicles while particularly focusing on compact cars and wireless base stations is particularly promoted from simplicity and safety of mounting as a liquid fuel and high output power density. In the anion conductive fuel cell, a strong acid condition as in the proton conductive fuel is not required during operation, and thus it is characterized most greatly in that instead of a noble metal such as platinum, inexpensive iron and cobalt, which cannot be utilized in the proton conductive fuel cell by reason of being dissolved in the strong acid condition, can be utilized for an electrode. Accordingly, a low-cost and high-output power fuel cell can be expected.

In such an anion conductive fuel cell, the electrolyte membrane (hereinafter referred to as “an anion conductive electrolyte membrane”) for the anion conductive fuel cell functions as so-called “the electrolyte” for conducting a hydroxide ion (an anion), further as “a separator” for not directly mixing methanol and hydrazine as a fuel with oxygen. In view of this, as the anion conductive electrolyte membrane, it is required that ion conductivity be high, chemical stability and heat resistance be exhibited for enduring a long-term use in an alkaline aqueous solution at a high temperature (>60° C.) as the operating condition of the cell, and water retentivity of the membrane be constant for keeping ion conductivity high. On the other hand, it is required by reason of a role as the separator that mechanical strength and dimensional stability of the membrane be excellent, and high barrier property against methanol, hydrazine, and oxygen be exhibited. However, currently, the anion conductive electrolyte membrane of practical use has hardly been developed, and the present anion conductive electrolyte membrane has the largest problem in durability such as remarkably low alkaline resistance in addition to lowness of performance such as ionic conductivity, mechanical strength, and fuel permeability, as compared with the proton conductive electrolyte membrane with favorable results of utilization, starting with Nafion (registered trademark).

Then, the development of the anion conductive electrolyte membrane for solving the above-described various problems has been actively promoted until now. For example, the anion conductive electrolyte membrane, in which a hydrocarbon film such as porous polyethylene is used as a substrate to fill cross-linked anion exchange resin into pores of the hydrocarbon film, is developed (Patent Documents 1 to 3). A production method of the anion conductive electrolyte membrane, in which a polymerization product of a mixture of haloalkyl styrene, elastomer, and an epoxy compound is used as a substrate membrane to introduce an alkyl ammonium salt by quaternization reaction (Patent Document 4), and a production method of the anion conductive electrolyte membrane, in which radiation graft polymerization of anion exchange group precursor monomer and after that the alkyl ammonium salt are introduced to a substrate made of a fluorine-based polymer (Patent Document 5), are proposed.

### PRIOR ART

### Patent Literature

Patent Document 1: JP-A-2002-367626

Patent Document 2: JP-A-2009-203455

Patent Document 3: JP-T-2019-518809

Patent Document 4: JP-A-2011-202074

Patent Document 5: JP-A-2000-331693

### DISCLOSURE OF THE INVENTION

### Problems to be Solved by the Invention

As described in Patent Documents 1 to 5, in the existing anion membrane, an anion exchange group has a very high water uptake and does not have strength for enduring use for the reason that the anion exchange group is an alkyl ammonium salt obtained by quaternization of alkylamine such as mainly trimethylamine. While an alkaline-resistant anion conductive electrolyte membrane with a partial imidazolium salt as an anion exchange group that suppresses a nucleophilic substitution reaction has also been reported, an elimination reaction due to another decomposition reaction occurs, and the alkaline resistance is insufficient.

Therefore, it is an object of the present invention to provide a resin composition having excellent alkaline resistance and a production method of this resin composition.

It is an object of the present invention to provide an electrochemical device that uses the above-described resin composition and allows improvement of an output power and durability.

### Solution to the Problems

As a result of intensive study on the above-described problem, the inventor has obtained a knowledge that in the resin composition, by ensuring a certain distance between a main chain and an ion conductive group and chemically protecting portions that become starting points of a nucleophilic substitution reaction and an elimination reaction, which are main cause of decomposition by alkali, by a bulky substituent, it becomes possible to impart alkaline resistance and functions related to improvement of ion conductivity to the resin composition, and has completed the present invention.

Namely, the present invention is the following resin composition, resin composition production method, and electrochemical device.

The resin composition of the present invention for solving the above-described problem includes a structural unit represented by the following formula (1),

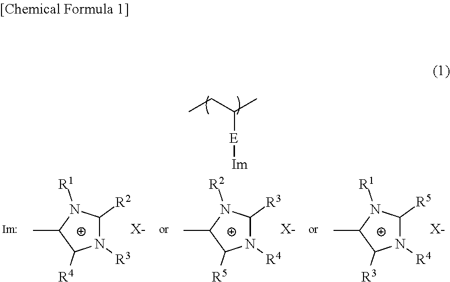

(In the formula, E is a spacer, and represents a benzene ring, a benzene derivative in which at least one atom is substituted with a hydrocarbon group having 1 to 6 carbon atoms, or a carbon chain having at least 2 carbon atoms and optionally including a heteroatom, Im represents an ion conductive group including an imidazole ring, R¹ to R⁵ each independently represent a carbon chain having 1 to 10 carbon atoms and including hydrogen, halogen or a heteroatom, X⁻ represents an anion).

According to this feature, as indicated in the formula (1), by disposing the spacer (E) between the main chain and the ion conductive group (Im), it becomes possible to promote improvement of the ion conductivity and improvement of alkaline resistance as the resin composition. In addition, by protecting each position in the imidazole ring of the ion conductive group (Im), it is possible to suppress the elimination reaction starting from β hydrogen, a hydrolysis reaction by a nucleophilic attack to a 2nd position, and an oxidative decomposition reaction against a 4th position and a 5th position and it becomes possible to further improve the alkaline resistance as the resin composition in addition to the effect obtained by disposing the spacer (E).

One embodiment of the resin composition of the present invention further includes the structural unit represented by the following formula (2),

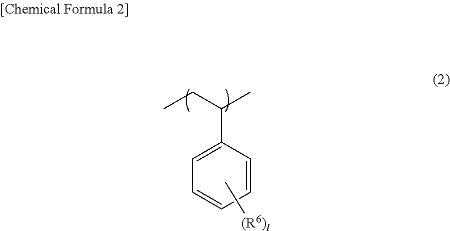

(In the formula, R⁶ represents a carbon chain having 1 to 10 carbon atoms and including hydrogen, halogen or the heteroatom,/represents an integer from 0 to 5).

According to this feature, by creating a structure that combines the formula (1) and the formula (2), it becomes possible to reduce repulsion between the positive charges of the ion conductive group (Im) in the formula (1), and by a steric protection effect of the benzene ring, it becomes possible to further suppress a nucleophilic substitution reaction to the carbon atom at a bonding position between the spacer (E) and the ion conductive group (Im) and a decomposition reaction of the imidazole ring in the ion conductive group (Im). With this, it becomes possible to further improve the alkaline resistance of the resin composition.

In one embodiment of the resin composition of the present invention, among the structural unit represented by the above formula (1), in the structural unit represented by the following formula (3), at least one of R¹ and R³ has 2 or more carbon atoms,

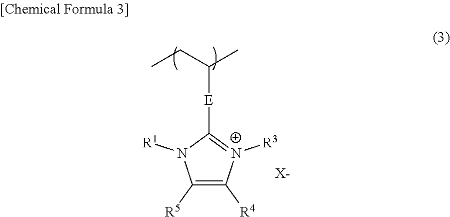

(In the formula, E is the spacer, and represents the benzene ring, the benzene derivative in which at least one atom is substituted with the hydrocarbon group having 1 to 6 carbon atoms, or the carbon chain having at least 2 carbon atoms and optionally including the heteroatom, R¹, R³, R⁴, R⁵ each independently represent the carbon chains having 1 to 10 carbon atoms and including hydrogen, halogen or the heteroatom, X⁻ represents the anion).

According to this feature, by making at least one of the protecting groups (R¹ and R³) related to the nitrogen atom of the imidazole ring in the ion conductive group (Im) bulky as a carbon chain having 2 or more carbon atoms, it becomes possible to enhance hydrophobicity, reduce the repulsion between the positive charges of the ion conductive group (Im) and suppress the elimination reaction and the decomposition reaction related to the ion conductive group (Im). With this, it becomes possible to further improve the ion conductivity and the alkaline resistance of the resin composition.

One embodiment of the resin composition of the present invention has ionic conductivity of 40 mS/cm or more and a maintenance factor of the ionic conductivity of 70% or more after immersion in 1M-potassium hydroxide aqueous solution heated to 80° C.for 200 hours.

According to this feature, by the ionic conductivity and the maintenance factor of the ionic conductivity as the resin composition satisfying specific values, it becomes possible to be utilized as a highly practical resin composition where functions related to the ion conductivity and the alkaline resistance are imparted. In particular, when this resin composition is utilized as a material in an electrochemical device such as a fuel cell and a metal-air battery, it becomes possible to utilize it as one having sufficient practical use.

A production method of a resin composition of the present invention for solving the above-described problem is the production method of the resin composition that includes a structural unit represented by the following formula (1) and includes a step of introducing the spacer (E) and/or the ion conductive group (Im) in the following formula (1) by radiation graft polymerization,

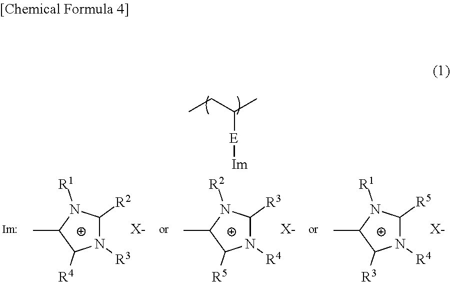

(In the formula, E is a spacer, and represents a benzene ring, a benzene derivative in which at least one atom is substituted with a hydrocarbon group having 1 to 6 carbon atoms, or a carbon chain having at least 2 carbon atoms and optionally including a heteroatom, Im represents an ion conductive group including an imidazole ring, R¹ to R⁵ each independently represent a carbon chain having 1 to 10 carbon atoms and including hydrogen, halogen or a heteroatom, X⁻ represents an anion).

According to this feature, by using the radiation graft polymerization that has a high degree of freedom in designing polymer chains and can introduce various ion conductive groups by a covalent bond, it becomes possible to easily produce the resin composition having the structural unit as designed.

Regarding the electrochemical device of the present invention for solving the above-described problem, in the electrochemical device including an electrolyte layer and two electrodes disposed oppositely with one another with the electrolyte layer sandwiched in between, the electrolyte layer and/or the electrode are formed by including the resin composition.

According to this feature, by using the resin composition having the high ion conductivity and alkaline resistance as a material of the electrolyte layer and/or electrode in the electrochemical device, it becomes possible to promote improvement of an output power and improvement of durability in the electrochemical device.

One embodiment of the electrochemical device of the present invention is a fuel cell or a metal-air battery.

According to this feature, by taking full advantage of the functions related to the high ion conductivity and alkaline resistance in the above-described resin composition, it becomes possible to solve the problems of low output power and low durability in conventional fuel cells or metal-air batteries and provide a highly practical fuel cell or metal-air battery.

### Effects of the Invention

According to the present invention, it is possible to provide a resin composition having excellent alkaline resistance and a production method of this resin composition.

According to the present invention, by using the above-described resin composition, it is possible to provide an electrochemical device that allow improvement of output power and improvement of durability.

### BRIEF DESCRIPTION OF DRAWINGS

FIG. 1 is a schematic explanatory view illustrating a structure of an electrochemical device according to an embodiment of the present invention.

FIG. 2 includes graphs illustrating results related to performance tests of the electrochemical device in examples and comparative examples of the present invention.

FIG. 3 is a graph illustrating a result related to a durability test of the electrochemical device in the examples and the comparative examples of the present invention.

### DESCRIPTION OF PREFERRED EMBODIMENTS

The following describes embodiments according to a resin composition, a resin composition production method, and an electrochemical device of the present invention in detail.

The resin composition, the production method, and the electrochemical device described in the embodiments are merely exemplified to explain the present invention, and the present invention is not limited thereto.

### Resin Composition

### (Structure of Resin Composition)

The resin composition in the embodiments of the present invention includes a structural unit represented by the following formula (1),

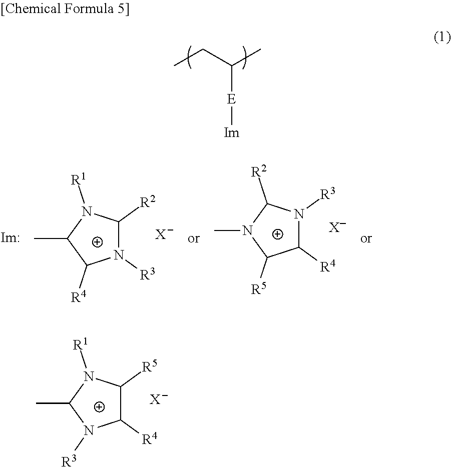

(In the formula, E is a spacer and represents a benzene ring, a benzene derivative in which at least one atom is substituted with a hydrocarbon group having 1 to 6 carbon atoms, or a carbon chain having at least 2 carbon atoms and optionally including a heteroatom, Im represents an ion conductive group including an imidazole ring, R¹ to R⁵ each independently represent a carbon chain having 1 to 10 carbon atoms and including hydrogen, a halogen, or a heteroatom, and X ⁻ represents an anion).

The spacer (E) in the formula (1) ensures a distance between a main chain and the ion conductive group (Im). With this, it becomes possible to improve ion conductivity as the resin composition. In addition, it becomes possible to improve alkaline resistance as the resin composition.

The spacer (E) is selected from the benzene ring, the benzene derivative in which at least one atom is substituted with a hydrocarbon group having 1 to 6 carbon atoms, or a carbon chain having at least 2 carbon atoms and optionally including the heteroatom. The heteroatom is preferably selected from nitrogen (N), oxygen (O), phosphorus (P), and sulfur (S).

Here, the distance between the main chain and the ion conductive group (Im) is preferably set to be within a range where the ion conductive group (Im) is under an influence of hydrophobicity of the main chain while a certain distance is ensured between the main chain and the ion conductive group (Im). With this, it becomes possible to suppress a hydrolysis reaction due to nucleophilic attack on the ion conductive group (Im) and to further improve the alkaline resistance while high ion conductivity as the resin composition is maintained.

Accordingly, the spacer (E) is preferably selected from the benzene derivative in which at least one of the hydrogen atoms in the benzene ring is substituted with a hydrocarbon group having 1 to 3 carbon atoms, or the carbon chai having 2 to 5 carbon atoms and optionally including the heteroatom, in addition to the benzene ring. Furthermore, considering a yield related to the production of the resin composition, ease of setting reaction conditions, ease of obtaining reaction raw materials, and the like, the spacer (E) is more preferably selected from the benzene ring or the benzene derivative in which at least one of the hydrogen atoms in the benzene ring is substituted with a hydrocarbon group having 1 to 3 carbon atoms.

The ion conductive group (Im) in the formula (1) is one having protecting groups (R¹ to R⁵) at each position of the imidazole ring.

Conventionally, an anion conductive electrolyte membrane including an alkylammonium hydroxide salt as the ion conductive group has problems that it is significantly unstable due to its strong basicity and do not have sufficient strength due to its high water-containing property.

On the other hand, in the ion conductive group (Im) in the embodiment of the present invention, by having the imidazole ring, as indicated in the formula (1), positive charges are dispersed by a conjugated structure and the basicity is reduced. With this, it is possible to reduce water uptake as the resin composition, and it becomes possible to obtain sufficient strength (stabilization) when used as the anion conductive electrolyte membrane.

By disposing the protecting groups (R¹ to R⁵) in the ion conductive group (Im), it becomes possible to suppress an elimination reaction starting from ß hydrogen, a hydrolysis reaction due to nucleophilic attack on a 2nd position, and an oxidative decomposition reaction on a 4th position and a 5th position. With this, it becomes possible to further improve the alkaline resistance as the resin composition, in addition to an effect of disposing the spacer (E).

It is only necessary that R¹ to R⁵ in the formula (1) are each independent carbon chains having 1 to 10 carbon atoms and including hydrogen, the halogen, or the heteroatom, and they are not particularly limited. The heteroatom is preferably selected from nitrogen (N), oxygen (O), phosphorus (P), and sulfur (S).

In R¹ to R⁵, “including the halogen” means that it may include, for example, a halogeno group such as a fluoro group, a chloro group, a bromo group, and an iodine group.

In R¹ to R⁵, “including the heteroatom” means that it may include, for example, a functional group containing nitrogen atoms such as an amino group (—NR₂), an ammonium group (—NR₃⁺), and a cyano group (—CN), the functional group containing oxygen atoms such as a hydroxyl group (—OH) and an alkoxy group (—OR), the functional group containing sulfur atoms such as a thiol (—SH), the functional group containing a plurality of heteroatoms such as a nitro group (—NO₂), an isocyanate group (—NCO), phosphonic acid (—P(═O)(OH)₂), phosphoric acid (—H₂PO₄), and thioester (—C(═O)S), and also means that it may include a linking group including the heteroatom such as an imino group (—NR—), an ether group (—O—), an amido group (—C(═O)—NR—), a phosphoric acid amido group (—P(═O)—NR—), a phosphine oxide group (—P(—O)R—), a phosphate ester group (—PO₄H—), a sulfide group (—S—), a disulfide group (—S—S—), and a sulfone group (—SO₂—) inside or at an end of a carbon skeleton.

Accordingly, as R¹ to R⁵, for example, a hydrocarbon group having two carbon atoms including the amino group such as —CH₂—CH₂—NH₂, the hydrocarbon group having two carbon atoms including the imino group such as —CH₂—NH—CH₃ inside the carbon skeleton, and the hydrocarbon group having two carbon atoms including the imino group such as —NH—CH₂—CH₃ at the end of the carbon skeleton are included.

It is only necessary that the number of carbon atoms in R¹ to R⁵ is usually 1 or more and 10 or less, preferably 6 or less, and more preferably 3 or less. R¹ to R⁵ are not limited to the straight-chain saturated hydrocarbon groups but are the hydrocarbon groups that may have a branched structure and/or a cyclic structure and may further have an unsaturated bond.

Example of the carbon chain (the hydrocarbon group) of R¹ to R⁵ having 1 to 10 carbon atoms include, for example, the straight-chain hydrocarbon groups having 1 to 10 carbon atoms such as a methyl group, an ethyl group, an n-the propyl group, an n-butyl group, an n-pentyl group, an n-hexyl group, an n-heptyl group, an n-octyl group, an n-nonyl group, and an n-decyl group, and branched chain hydrocarbon groups having 1 to 10 carbon atoms such as an i-propyl group, an i-butyl group, an s-butyl group, a t-butyl group, an i-pentyl group, an s-pentyl group, a t-pentyl group, a neopentyl group, an i-hexyl group, a 3-methylpentyl group, a 2-methylpentyl group, an 1-methylpentyl group, an 1-ethylbutyl group, a 2-ethylbutyl group, an 1,2-dimethylbutyl group, and a 2,3-dimethylbutyl group, and cyclic hydrocarbon groups having 3 to 10 carbon atoms such as a cyclohexyl group, a cyclopentylmethyl group, and a cyclohexylmethyl group. Example of the carbon chain of R¹ to R⁵ having 1 to 10 carbon atoms include preferably the hydrocarbon group having 3 to 8 carbon atoms, more preferably the methyl group, the ethyl group, the n-propyl group, the n-butyl group, the n-pentyl group, and the n-hexyl group, further preferably the methyl group, the ethyl group, the n-propyl group.

While X⁻ in the formula (1) is the anion that serves as a counter ion to the ion conductive group (Im), it is only necessary that it can form an imidazolium salt, and specific kinds of anions are not particularly limited. Accordingly, while examples of the X⁻ include, for example, halogen ions such as a hydroxide ion, a carbonate ion, a nitrate ion, a sulfate ion, a phosphate ion, and the halogen ion such as a chloride ion, a bromide ion, and an iodide ion, the hydroxide ion is particularly preferable.

In the resin composition of this embodiment, an example of the structure based on the formula (1) is indicated in a formula (4),

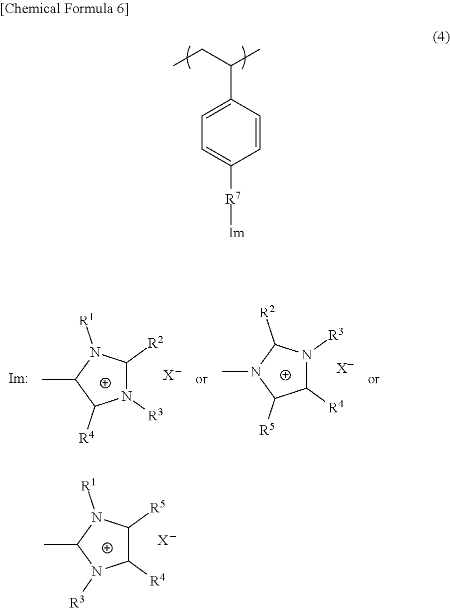

(In the formula, R⁷ represents the hydrocarbon group having a single bind or having 1 to 6 carbon atoms, Im represents the ion conductive group including an imidazole ring, R¹ to R⁵ each independently represent the carbon chain having 1 to 10 carbon atoms and including hydrogen, the halogen or the heteroatom, and X⁻ represents the anion).

Since the resin composition of this embodiment has the structural unit of the formula (4), it becomes possible to easily and reliably secure a suitable distance between the main chain and the ion conductive group (Im) by a rigid benzene ring skeleton. In addition, since positive charges are dispersed by n electrons of the benzene ring in the formula (4), the resin composition of this embodiment becomes one having advantages of promoting stabilization of the resin composition, and the like.

While it is only necessary that the resin composition in the embodiment of the present invention is one having the structural unit represented by the above-described formula (1), and other structures are not particularly limited, in addition to the structural unit represented by the formula (1), it is preferable to further have a structural unit represented by a formula (2) below,

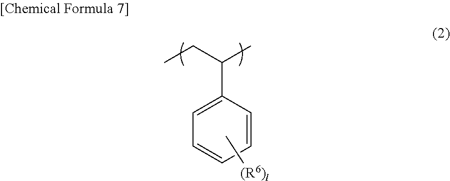

(In the formula, R⁶ represents a carbon chain having 1 to 10 carbon atoms and including hydrogen, the halogen, or the heteroatom, l represents an integer from 0 to 5).

It is only necessary that similarly to R¹ to R⁵ described above, R⁶ in the formula (2) is the carbon chain having 1 to 10 carbon atoms and including hydrogen, the halogen, or the heteroatom, and is not particularly limited. The heteroatom is preferably selected from nitrogen (N), oxygen (O), phosphorus (P), and sulfur (S).

Similarly to R¹ to R⁵ described above, it is only necessary that the number of carbon atoms of R⁶ is usually 1 or more and 10 or less, preferably 6 or less, more preferably 3 or less. R⁶ is not limited to the straight-chain saturated hydrocarbon group but is the hydrocarbon group that may have the branched structure and/or the cyclic structure and may further have the unsaturated bond.

R⁶ preferably has a halogeno group in the carbon chain having 1 to 3 carbon atoms, and examples of the halogeno group include, for example, a chloromethyl group, a bromomethyl group, a chloroethyl group, a bromoethyl group, a chloropropyl group, and a bromopropyl group, and the like.

By making the resin composition in the embodiment of the present invention have a structure that combines the formula (1) and the formula (2), it becomes possible to reduce repulsion between the positive charges of the ion conductive group (Im) in the formula (1) and by a steric protection effect of the benzene ring, further suppress a nucleophilic substitution reaction to the carbon atom at a bonding position between the spacer (E) and the ion conductive group (Im) and a decomposition reaction of the imidazole ring in the ion conductive group (Im). With this, it becomes possible to further improve the alkaline resistance of the resin composition.

The specific structure of the resin composition of this embodiment, which is a combination of the formula (1) and the formula (2), is as indicated in a formula (5),

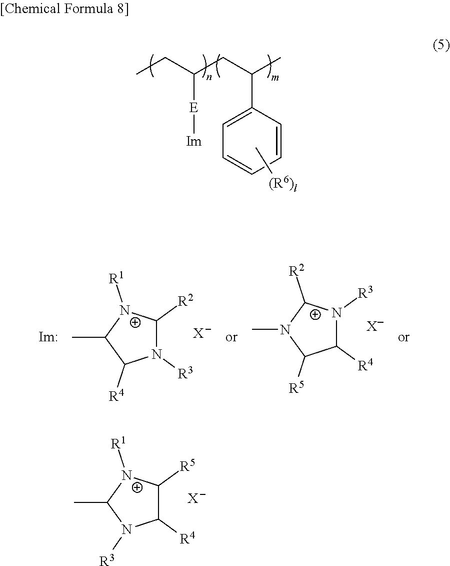

(In the formula, E is the spacer and represents the benzene ring, the benzene derivative in which at least one atom is substituted with the hydrocarbon group having 1 to 6 carbon atoms, or the carbon chain having at least 2 carbon atoms and optionally including the heteroatom, Im represents the ion conductive group including an imidazole ring, R¹ to R⁶ each independently represent the carbon chain having 1 to 10 carbon atoms and including hydrogen, the halogen, or the heteroatom, X⁻ represents the anion, and n and m represent a mole ratio).

Here, in the formula (5), when the mole ratio (value of m) of the structural unit based on the formula (2) becomes too small, a sufficient steric protection effect of the benzene ring cannot be obtained. On the other hand, in the formula (5), it is undesirable that the mole ratio (value of m) of the structural unit based on the formula (2) becomes too large to make the resin composition more hydrophobic than necessary. Accordingly, the value of the mole ratio (n:m) in the formula (5) is preferably n:m=8:2 to 2:8, more preferably n:m=7:3 to 4:6.

An example of another aspect of the resin composition in the embodiment of the present invention preferably has a structural unit represented by a formula (3) below among the structural units represented by the above-described formula (1) and makes at least one of R¹ and R³ have 2 or more carbon atoms,

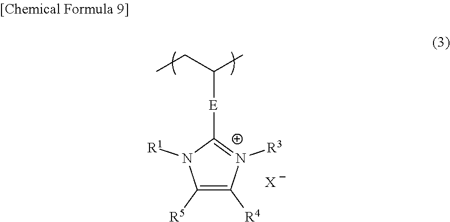

(in the formula, E is the spacer and represents the benzene ring, the benzene derivative in which at least one atom is substituted with the hydrocarbon group having 1 to 6 carbon atoms, or the carbon chain having at least 2 carbon atoms and optionally including the heteroatom, R¹, R³, R⁴, R⁵ each independently represent the carbon chain having 1 to 10 carbon atoms and including hydrogen, the halogen, or the heteroatom, X⁻ represents the anion).

The spacer (E) and the protecting groups (R¹, R³, R⁴, R⁵) in the formula (3) are similar to the spacer and the protecting groups in the above-described formula (1). However, it is assumed that at least one of R¹ and R³ has 2 or more carbon atoms.

At this time, in view of/considering stability (low water-containing property) as the resin composition, yield related to production, and the like, it is preferable that R¹ and R³ have 6 or less carbon atoms, and R¹ and R³ have different number of carbon atoms with one another.

By making at least one of the protecting groups (R¹ and R³) related to the nitrogen atom of the imidazole ring bulky as a carbon chain having 2 or more carbon atoms among the protecting groups (R¹, R³, R⁴, R⁵) in the formula (3), it becomes possible to enhance hydrophobicity, reduce the repulsion between the positive charges of the ion conductive group (Im) and suppress the elimination reaction and the decomposition reaction related to the ion conductive group (Im). With this, it becomes possible to further improve the ion conductivity and the alkaline resistance of the resin composition.

In the resin composition having the structural unit of the formula (3), since the ion conductive group (Im) itself has the bulky protecting group, it becomes possible to suppress the decomposition reaction of the ion conductive group (Im) even when there is no steric protection effect by disposing the structural unit of the formula (2). In view of this, in the resin composition having the structural unit of the formula (3), while it is not required to actively include the structural unit of the formula (2), combination of the structural unit of the formula (3) and the structural unit of the formula (2) is not excluded.

### (Production Method of Resin Composition)

The resin composition in the embodiment of the present invention can be produced by a method including a step of introducing the spacer (E) and/or the ion conductive group (Im) in the formula (1) by radiation graft polymerization.

It is known that the radiation graft polymerization has a high degree of freedom in designing polymer chains and can introduce various ion conductive groups by covalent bonds. In view of this, by using the radiation graft polymerization in the production of the resin composition in the embodiment of the present invention, it becomes possible to easily produce the resin composition having the structural unit as indicated in the formula (1) or the formula (2).

One example related to the production of the resin composition in the embodiment of the present invention includes introducing a compound having a structure that becomes the spacer (E) in the formula (1) into a polymer substrate by performing the radiation graft polymerization and replacing part of the introduced functional group with a compound having a structure that becomes an on conductive group (Im) in the formula (1). This production method will be specifically exemplified in Example 1-1, which will be described later.

Another example related to the production of the resin composition in the embodiment of the present invention includes introducing a compound having a structure that becomes the spacer (E) and the ion conductive group (Im) in the formula (1) into a polymer substrate by performing the radiation graft polymerization. This production method will be specifically exemplified in Example 1-2, which will be described later.

In the following, in the explanation related to the production of the resin composition, it is assumed that a compound (monomer) that is introduced into a polymer substrate by the radiation graft polymerization and includes the structure of the spacer (E) and/or the ion conductive group (Im) in the formula (1) is referred to as “a starting raw material.”

Here, as the polymer substrate, ones made of fluorine-based polymer, olefin-based polymer, aromatic polymers, and the like are used.

Examples of the fluorine-based polymers include polytetrafluoroethylene (PTFE), tetrafluoroethylene-hexafluoropropylene copolymer (FEP), tetrafluoroethylene-perfluoroalkylvinyl ether copolymer (PFA), polyvinylidene fluoride (PVDF), ethylene-tetrafluoroethylene copolymer (ETFE), polyvinyl fluoride (PVF), and polychloro-trifluoroethylene copolymer (ECTFE). When the polymer substrate made of the fluorine-based polymer is used, by preliminarily cross-linking the fluorine-based polymer, heat resistance and swelling inhibitory capacity of the resin composition can be improved, and in particular, performance as an anion conductive electrolyte membrane can be improved.

Examples of the olefin-based polymer include low density, high density, and ultra-high molecular weight polyethylene and polypropylene. Polymers having trimethylpentane as a polymerization unit can also be included. When the polymer substrate made of the olefin-based polymer is used, by preliminarily cross-linking the olefin-based polymer, the heat resistance and swelling inhibitory capacity of the resin composition can be further improved.

Examples of the aromatic polymer include polyimide, polyamideimide, polyetherimide, polyethylene naphthalate, liquid crystalline aromatic polymer, polyether ether ketone, polyphenylene oxide, polyphenylene sulfide, polysulfone, and polyethersulfone, which are referred to as high-performance resin (super engineering plastic). When the polymer substrate made of the aromatic polymer is used, by preliminarily cross-linking the aromatic polymer, the heat resistance and swelling inhibitory capacity of the resin composition can be further improved.

As the resin composition in the embodiment of the present invention, in particular, with the aim of improving the durability and suppressing the swelling of the anion conductive electrolyte membrane, a composite material of a thermoplastic resin and various kinds of inorganic fillers or a polymer alloy can also be used as the polymer substrate.

Specific methods, conditions, and the like of the radiation graft polymerization are not particularly limited, and known methods can be appropriately employed. While, for example, specific methods include a simultaneous irradiation method in which a polymer substrate and a starting raw material are simultaneously irradiated with radiation to undergo graft polymerization and a pre-irradiation method in which the polymer substrate is first irradiated with radiation, and the polymer substrate is brought into contact with the starting raw material to undergo graft polymerization, the pre-irradiation method is preferable because an amount of homopolymer generation is smaller.

Regarding the pre-irradiation method, known methods such as a polymer radical method in which the polymer substrate is irradiated with radiation in an inert gas and a peroxide method in which the polymer substrate is irradiated with radiation in presence of oxygen can be used.

Radiation in radiation graft polymerization means ionizing radiation such as electron beam, γ ray, and ion beam, an energy amount of the radiation is usually 1 kGy or more, preferably 5 kGy or more, more preferably 10 kGy or more, and usually 500 kGy or less, preferably 100 kGy or less, more preferably 50 kGy or less.

A temperature condition during radiation irradiation is usually room temperature, usually 150° C. or lower, preferably 50° C. or lower, more preferably 30° C. or lower.

When it is within the above-described range, sufficient ion conductivity can be ensured, and deterioration of the polymer substrate can be suppressed.

When the step related to the radiation graft polymerization of the present invention is the pre-irradiation method, a method of contacting the polymer substrate with the starting raw material is not particularly limited and includes a method of immersing the polymer substrate after irradiation with radiation in a solution containing the starting raw material.

Examples of a solvent used for the solution containing the starting raw material include dichloroethane, chloroform, N-methylformaldehyde, N-methylacetamide, N-methylpyrrolidone, γ-butyrolactone, n-hexane, dioxane, methanol, ethanol, 1-propanol, tert-butanol, toluene, xylene, cyclohexane, cyclohexanone, dimethylsulfoxide.

A concentration of the starting raw material in the solution is not particularly limited and can be appropriately set depending on a purpose. For example, the concentration of the starting raw material is usually 10 weight % or more, preferably 30 weight % or more, more preferably 50 weight % or more, and usually 100 weight % or less, preferably 80 weight % or less, more preferably 60 weight % or less.

An immersion temperature is usually room temperature or higher, preferably 40° C. or higher, more preferably 50° C. or higher, and usually 120° C. or lower, preferably 100° C. or lower, more preferably 80° C. or lower.

An immersion time is usually 0.5 hours or more, preferably 1 hour or more, more preferably 2 hours or more, and usually 100 hours or less, preferably 20 hours or less, more preferably 5 hours or less.

When it is within the above-described range, a sufficient grafting degree can be ensured, and deterioration of the polymer substrate can be suppressed.

In addition to the step related to the above-described radiation graft polymerization, the production method of the resin composition in the embodiment of the present invention may include a reaction step of imparting functions according to various kinds of applications to the resin composition in the embodiment of the present invention.

For example, regarding the resin composition in which the spacer (E) and the ion conductive group (Im) are introduced into the polymer substrate using the radiation graft polymerization, the production method may include an N-alkylation step in which the nitrogen atom of the ion conductive group (Im) undergoes N-alkylation, and an ion exchange step in which an anion (X) as a counter ion is replaced with a desired anion.

For example, the N-alkylation step includes alkylating all or part of the nitrogen atoms in the imidazole ring (imidazole derivative) structure of the introduced ion conductive group (Im). Here, a specific method, conditions, and the like of the N-alkylation are not particularly limited, and known methods can be appropriately employed. The N-alkylation step according to the present invention is preferably a step of alkylation with an alkyl halide having 1 to 10 carbon atoms.

The alkyl halide used in the N-alkylation step can be appropriately selected depending on the purpose, and the number of carbon atoms is usually 1 or more and usually 10 or less, preferably 6 or less, more preferably 3 or less. Examples of the halogen atom of the alkyl halide include chlorine, bromine, and iodine. For example, specific examples of the alkyl halide include methyl iodide, ethyl iodide, propyl iodide, isopropyl iodide, and particularly propyl iodide.

Examples of the solvent used in the N-alkylation step include alcohols such as methanol, ethanol, and propanol, ethers such as dioxane, the aromatic hydrocarbons such as toluene and xylene, aprotic polar solvents such as N,N-dimethylformamide (DMF) and dimethylsulfoxide (DMSO).

A reaction temperature is usually 5° C. or higher, preferably 40° C. or higher, and usually 100° C. or lower, preferably 95° C. or lower.

A reaction time is usually 2 hours or more, preferably 24 hours or more, and usually 72 hours or less, preferably 48 hours or less.

In the N-alkylation step according to the present invention, while a specific amount of introduction and the like are not particularly limited as long as it alkylates at least a part of the nitrogen atoms in the imidazole ring (imidazole derivative) structure, a reaction yield of the N-alkylation is usually 30% or more, preferably 50% or more, more preferably 70% or more.

For example, the ion exchange step includes contacting the resin composition obtained by the radiation graft polymerization step and the N-alkylation step with a solution containing the desired anion and replacing the anion (X) as a counter ion with the desired anion.

For example, the resin composition that has undergone the N-alkylation step using the alkyl halide usually has a halogen ion as a counter ion to the ion conductive group (Im). Accordingly, when the resin composition is used as an anion conductive electrolyte membrane, it is preferable to replace the halogen ion with a hydroxide ion as a counter ion.

At this time, it is only necessary that an ion replacement step is one in which the resin composition that has undergone the step related to the radiation graft polymerization and the N-alkylation is brought into contact with a solution containing the hydroxide ion, and specific methods, conditions, and the like are not particularly limited, and known methods can be appropriately employed.

The solution containing the hydroxide ion includes the aqueous solutions such as sodium hydroxide and potassium hydroxide.

The concentration of the hydroxide ion in the solution is usually 0.1 mol/L or more, preferably 0.5 mol/L or more, and usually 5 mol/L or less, more preferably 2 mol/L or less.

The immersion temperature is usually 5° C. or higher, preferably 20° C. or higher, and usually 80° C. or lower, preferably 60° C. or lower.

The immersion time is usually 2 hours or more, preferably 16 hours or more, and usually 48 hours or less, preferably 24 hours or less. In order to complete the ion replacement step of an equilibrium reaction, it is desirable to perform an operation of replacing the solution during immersion.

### Electrochemical Device

The above-described resin composition in the embodiment of the present invention can be suitably used as a material in an electrochemical device.

In particular, as a material for an electrolyte layer and/or an electrode in an electrochemical device that includes the electrolyte layer and two electrodes disposed oppositely with one another with the electrolyte layer sandwiched in between, the resin composition in the embodiment of the present invention can be suitably used. It is only necessary that “a material for an electrode” is one for forming a part of a structure related to the electrode, and it includes a binding material (a binder) for a catalyst and an active material.

It is only necessary that the electrochemical device of the present invention includes an electrolyte layer and an electrode, and it includes a fuel cell, a metal-air battery, an electrolytic bath, and the like. In particular, the electrochemical device of the present invention is preferably a fuel cell or a metal-air battery. With this, by taking full advantage of the functions related to the high ion conductivity and alkaline resistance in the above-described resin composition, it becomes possible to solve the problem of low output power and low durability in conventional fuel cells and metal-air batteries, and to provide highly practical fuel cells or metal-air batteries.

Hereinafter, as the electrochemical device of the present invention, a fuel cell will be mainly explained, but it is not limited thereto.

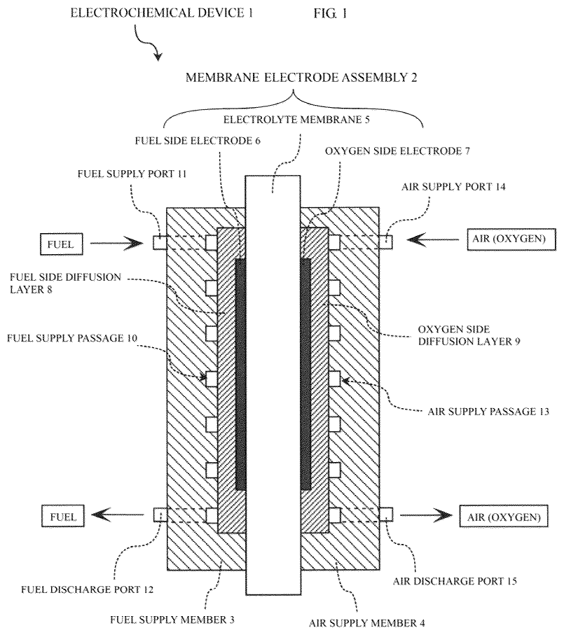

FIG. 1 is a schematic explanatory view illustrating a structure of an electrochemical device (a fuel cell) according to the embodiment of the present invention.

An electrochemical device 1 according to this embodiment is an anion conductive fuel cell to which a liquid fuel component is directly supplied.

Examples of the fuel component supplied to the electrochemical device 1 include hydrogen, methanol, ammonia, hydrazines (including hydrazine hydrate, anhydrous hydrazine (hydrazine), and the like).

As illustrated in FIG. 1, the electrochemical device 1 is formed in a stacked structure in which a plurality of cells (unit cells) of the fuel cell that includes a membrane electrode assembly 2, a fuel side diffusion layer 8, an oxygen side diffusion layer 9, a fuel supply member 3 disposed on one side (an anode side) of the membrane electrode assembly 2, and an air supply member 4 disposed on the other side (a cathode side) of the membrane electrode assembly 2 are stacked. In FIG. 1, among the plurality of unit cells, only one cell is represented as the electrochemical device 1, and other unit cells are omitted.

The membrane electrode assembly 2 includes an electrolyte membrane 5 as the electrolyte layer, a fuel side electrode 6 made of a catalyst layer formed on one-side surface (hereinafter simply referred to as “one surface”) in a thickness direction of the electrolyte membrane 5, and an oxygen side electrode 7 made of a catalyst layer formed on the other-side surface (hereinafter simply referred to as “the other surface”) in a thickness direction of the electrolyte membrane 5.

Namely, the membrane electrode assembly 2 has a structure in which the fuel side electrode 6 and the oxygen side electrode 7 are disposed oppositely with one another with the electrolyte membrane 5 sandwiched in between.

The electrolyte membrane 5 is not particularly limited as long as it is a layer in which an anion component (for example, the hydroxide ion (OH⁻) or the like) can move and has a function that allows movement of the anion component. For example, examples of the electrolyte membrane 5 include one that is formed using the above-described resin composition.

The fuel side electrode 6 is formed of a catalyst layer formed from a cell-electrode catalyst layer composition including a binder for forming an electrode catalyst layer and a catalyst.

The catalyst is not particularly limited, and examples of the catalyst include, for example, periodic table group 8 elements to 10 (VIII) elements such as platinum group elements (ruthenium (Ru), rhodium (Rh), palladium (Pd), osmium (Os), iridium (Ir), and platinum (Pt)) and iron group elements (iron (Fe), cobalt (Co), nickel (Ni)), and periodic table group 11 (IB) elements such as copper (Cu), silver (Ag), gold (Au). These catalysts can be used alone or in combination of two kinds or more.

The catalyst may be supported on a catalyst carrier. Examples of the catalyst carrier include, for example, porous substances such as carbon and ceramic materials.

To form the catalyst layer of the fuel side electrode 6, first, a catalyst ink (a solution containing the cell-electrode catalyst layer composition) for the fuel side electrode 6 is prepared.

Examples of preparing the catalyst ink for the fuel side electrode 6 include adding a binder for forming the electrode catalyst layer to the above-described catalyst and stirring it.

Here, as the binder for forming the electrode catalyst layer, it is possible to use the above-described resin composition. More specifically, examples of the binder for forming the electrode catalyst layer includes using a binder where the above-described resin composition is shredded or freeze-pulverized and then dispersed in a solvent.

At this time, examples of the solvent include known solvents of, for example, low alcohols such as methanol, ethanol, and 1-propanol, for example, ethers such as tetrahydrofuran (THF) and dioxane, for example, ketones such as acetone and methyl ethyl ketone, for example, the aprotic polar solvent such as N-methyl pyrrolidone, and water. The stirring temperature at this time is, for example, 10° C. to 30° C., and the stirring time is, for example, 1 to 60 minutes. These solvents can be used alone or in combination of two kinds or more.

With this, the catalyst ink for the fuel side electrode 6 can be prepared.

Then, the prepared catalyst ink for the fuel side electrode 6 is applied onto a material serving as an electrode substrate and dried to form the catalyst layer. At this time, as the material serving as the electrode substrate, it is preferable to use a porous body, and for example, the electrolyte membrane 5 or the fuel side diffusion layer 8 may be used. In this case, the catalyst ink for the fuel side electrode 6 is applied onto one surface of the electrolyte membrane 5 or the fuel side diffusion layer 8 and is dried to form the catalyst layer.

Examples of an application method of the catalyst ink for the fuel side electrode 6 include, for example, known application methods such as a spray method, a die coater method, and inkjet method, and preferably a spray method.

A trying temperature is, for example, 10° C.to 40° C.

Thus, the fuel side electrode 6 made of the catalyst layer can be obtained.

Similarly to the fuel side electrode 6, the oxygen side electrode 7 is formed of a catalyst layer formed from a cell-electrode catalyst layer composition including a binder for forming an electrode catalyst layer and a catalyst.

In addition to using the catalyst similar to that of the above-described fuel side electrode 6, the catalyst of the oxygen side electrode 7 may be formed of, for example, a material in which a transition metal is supported on a composite (hereinafter, this composite will be referred to as “a carbon composite”) made of a complex-forming organic compound and/or an electroconductive polymer and carbon.

Examples of the transition metal include, for example, scandium (Sc), titanium (Ti), vanadium (V), chrome (Cr), manganese (Mn), iron (Fe), cobalt (Co), nickel (Ni), copper (Cu), yttrium (Y), zirconium (Zr), niobium (Nb), molybdenum (Mo), technetium (Tc), ruthenium (Ru), rhodium (Rh), palladium (Pd), silver (Ag), lanthanum (La), hafnium (Hf), tantalum (Ta), tungsten (W), rhenium (Re), osmium (Os), iridium (Ir), platinum (Pt), and gold (Au). These transition metal can be used alone or in combination of two kinds or more.

The complex-forming organic compound is an organic compound that forms a complex with a metal atom by coordinating with the metal atom, and examples of the complex-forming organic compound include, for example, pyrrole, porphyrin, tetramethoxyphenylporphyrin, dibenzotetraazaannulene, phthalocyanine, choline, chlorin, phenanthroline, salcomine, benzoimidazole, aminobenzimidazole, nicarbazin, diaminomaleonitrile, carbendazim, aminoantipyrine, or polymers of these are included. These complex-forming organic compound can be used alone or in combination of two kinds or more.

While there are some compounds that overlap with the above-described complex-forming organic compound, examples of the electroconductive polymer include, for example, polyaniline, polypyrrole, polythiophene, polyacetylene, polyvinylcarbazole, polytriphenylamine, polypyridine, polypyrimidine, polyquinoxaline, polyphenylquinoxaline, polyisothianaphthene, polypyridinediyl, polythienylene, polyparaphenylene, polyflurane, polyacene, polyfuran, polyazulene, polyindole, polydiaminoanthraquinone. These electroconductive polymer can be used alone or in combination of two kinds or more.

Similarly to the case of forming the catalyst layer of the above-described fuel side electrode 6, in order to form the catalyst layer of the oxygen side electrode 7, first, a catalyst ink (a solution including the cell-electrode catalyst layer composition) for the oxygen side electrode 7 is prepared.

The catalyst ink for the oxygen side electrode 7 is prepared, for example, similarly to the catalyst ink for the above-described fuel side electrode 6.

The catalyst ink for the oxygen side electrode 7 may be prepared, for example, by forming a carbon composite and then causing the carbon composite to support a transition metal.

Similarly to the case of preparing the catalyst ink for the fuel side electrode 6, in order to prepare the catalyst ink for the oxygen side electrode 7, adding the above-described binder for forming an electrode catalyst layer to the above-described catalyst to stir it is included.

With this, the catalyst ink for the oxygen side electrode 7 can be prepared.

Then, similarly to the catalyst ink for the fuel side electrode 6, the prepared catalyst ink for the oxygen side electrode 7 is applied to a material (for example, the other surface of the electrolyte membrane 5 or one surface of the oxygen side diffusion layer 9) serving as an electrode substrate and is dried to form a catalyst layer.

Thus, the oxygen side electrode 7 made of the catalyst layer can be obtained.

Then, to manufacture the membrane electrode assembly 2, the fuel side electrode 6 and the oxygen side electrode 7 are joined to the electrolyte membrane 5. At this time, the fuel side diffusion layer 8 and the oxygen side diffusion layer 9, which will be described later, may be joined together.

Means for joining the fuel side electrode 6 and the oxygen side electrode 7 to the electrolyte membrane 5 is not particularly limited.

For example, pressurizing the electrolyte membrane 5 on which the fuel side electrode 6 and the oxygen side electrode 7 are formed from both sides in a thickness direction of the electrolyte membrane 5 is included. To pressurize the electrolyte membrane 5, for example, a hydraulic pressing machine or the like is used. At this time, heating may be performed simultaneously with pressurization (hot press). By hot pressing, the fuel side electrode 6 and the oxygen side electrode 7 can be joined to the electrolyte membrane 5 at a lower pressure.

Another example includes joining the one in which the fuel side electrode 6 formed on the fuel side diffusion layer 8, the electrolyte membrane 5, and the oxygen side electrode 7 formed on the oxygen side diffusion layer 9 are stacked inside the cell in this order, by using a fixture, or the like.

With this, the membrane electrode assembly 2 is manufactured.

The fuel side diffusion layer 8 supplies fuel to the fuel side electrode 6 and has functions related to current collection of electrons generated in a chemical reaction, protection of the electrolyte membrane 5, and the like. The fuel side diffusion layer 8 is preferably one that has gas permeability and electrical conductivity, as well as durability and mechanical strength, and examples of the fuel side diffusion layer 8 include, for example, carbon paper or carbon cloth, and a gas permeability material including carbon paper or carbon cloth that have been treated with fluorine when necessary.

The fuel side diffusion layer 8 is available as a commercial product and examples of the commercial product include, for example, B-1 Carbon Cloth Type A No wet proofing (manufactured by BASF), ELAT (registered trademark: manufactured by BASF), SIGRACET (registered trademark: manufactured by SGL), and the like.

The oxygen side diffusion layer 9 supplies air (oxygen) to the oxygen side electrode 7, and has functions related to current collection of electrons generated in the chemical reaction, protection of the electrolyte membrane 5, discharge of generated water, and the like. Examples of the oxygen side diffusion layer 9 include, for example, the gas permeability material exemplified as the fuel side diffusion layer 8.

As described above, the fuel side diffusion layer 8 and the oxygen side diffusion layer 9 may be ones that have the fuel side electrode 6 and the oxygen side electrode 7 formed on their respective surfaces and have a function as electrodes, and may be ones that are disposed separately from the fuel side electrode 6 and the oxygen side electrode 7 formed on the electrolyte membrane 5 to have a function related to protection of the electrodes.

When the fuel side diffusion layer 8 and the oxygen side diffusion layer 9 have the protection function of the electrodes, examples of the arrangement of the fuel side diffusion layer 8 and the oxygen side diffusion layer 9 include laminating the fuel side diffusion layer 8 on the one surface of the electrolyte membrane 5 so as to cover the fuel side electrode 6 and laminating the oxygen side diffusion layer 9 on the other surface of the electrolyte membrane 5 so as to cover the oxygen side electrode 7, respectively.

At this time, means for lamination of the fuel side diffusion layer 8 and the oxygen side diffusion layer 9 on the electrolyte membrane 5 is not particularly limited. For example, examples of the means for lamination include fixing with a gasket or the like and pressurizing from the outside (including hot press).

The fuel supply member 3 is made of an electrically conductive member with gas-impermeability and supplies a liquid fuel to the fuel side electrode 6. The fuel supply member 3 has grooves formed to have a shape depressed from the surface of it, for example, a meander shape, or the like. Then, examples of the fuel supply member 3 include one having a grooved surface opposed to and brought into contact with the fuel side electrode 6. With this, between one surface of the fuel side electrode 6 and the other surface (the surface where the groove is formed) of the fuel supply member 3, a fuel supply passage 10 for bringing a fuel component into contact with the entire fuel side electrode 6 is formed.

The fuel supply passage 10 has a fuel supply port 11 for causing the fuel component to flow into the fuel supply member 3 formed on one-end side (upper side of the paper in FIG. 1) of it and a fuel discharge port 12 for discharging the fuel component from the fuel supply member 3 formed on an other-end side (lower side of the paper in FIG. 1) of it.

The air supply member 4 is one that is made of the electrically conductive member with gas-impermeability and supplies air (oxygen) to the oxygen side electrode 7. The air supply member 4 has grooves formed to have a shape depressed from the surface of it, for example, a meander shape, or the like. Then, examples of the air supply member 4 include one that has a grooved surface opposed to and is brought into contact with the oxygen side electrode 7. With this, between the other surface of the oxygen side electrode 7 and one surface (the surface where the groove is formed) of the air supply member 4, an air supply passage 13 for bringing air (oxygen) into contact with the entire oxygen side electrode 7 is formed.

The air supply passage 13 has an air supply port 14 for causing the air (oxygen) flow into the air supply member 4 formed on one-end side (upper side of the paper in FIG. 1) of it and an air discharge port 15 for discharging the air (oxygen) from the air supply member 4 formed on an other-end side (lower side of the paper in FIG. 1) of it.

An outline of an operation related to the above-described electrochemical device 1 will be explained.

In the electrochemical device 1, the fuel component is supplied to the fuel side electrode 6 from the fuel supply port 11. On the other hand, air (oxygen) is supplied to the oxygen side electrode 7 from the air supply port 14.

On the anode side, the liquid fuel passes through the fuel supply passage 10 while being brought into contact with the fuel side electrode 6. On the other hand, on the cathode side, air (oxygen) passes through the air supply passage 13 while being brought into contact with the oxygen side electrode 7.

Then, an electrochemical reaction occurs at each electrode (the fuel side electrode 6 and the oxygen side electrode 7), and an electromotive force is generated.

### EXAMPLES

Next, while the present invention will be described based on examples and comparative examples, it is not limited to the following examples.

### Resin Composition

### Example 1-1

An EFTE membrane with a film thickness of 25 μm (manufactured by DuPont Co.) was irradiated with y rays of 50 kGy under an argon atmosphere at room temperature, and then immersed in a degassed chloromethylstyrene (CMS)/xylene solution (CMS:xylene═1:1) for 2 hours in a constant temperature bath of 60° C.to perform graft polymerization of CMS with a ETFE main chain (a grafting degree of 77%).

The obtained graft membrane was immersed in an ethanol solution of 1,2,4,5-tetramethylimidazole (a concentration of 1M) and reacted in a constant temperature bath of 60° C.for 24 hours. The obtained graft membrane was washed in acetone and then dried in vacuum to obtain the resin composition having a chloride ion as a counter anion with a reaction yield of N-alkylation of 70%. A part of the obtained resin composition was freeze-pulverized and used as a binder material for forming the electrode catalyst layer.

The obtained resin composition was immersed in a 1M-potassium hydroxide aqueous solution at room temperature for 16 hours to replace the counter ion with the hydroxide ion, and then by repeating washing twice in deionized water, from which carbonic acid was removed by nitrogen bubbling, and further immersing it in the 1M-potassium hydroxide aqueous solution for 30 minutes twice, the resin composition (the anion conductive electrolyte membrane) having the hydroxide ion as a counter ion was obtained.

The structure of the resin composition in Example 1-1 is indicated in the following formula (6).

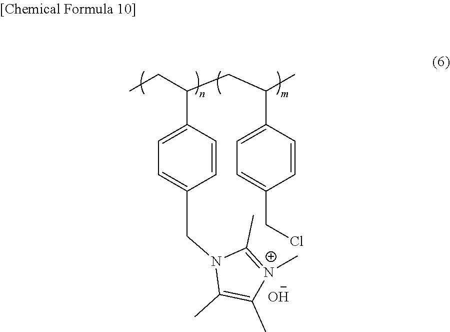

(In the formula, n and m represent the mole ratio)

In Example 1-1, in the formula (6), n:m=7:3.

### Example 1-2

An EFTE membrane with a film thickness of 25 μm (manufactured by DuPont Co.) was irradiated with y rays of 50 kGy under an argon atmosphere at room temperature, and then immersed in a degassed 2-(4-ethenylphenyl)-1,4,5-trimethyl-1H-imidazole (St-TMIm)/1,4-dioxane solution (St-TMIm:dioxane═1:1) for 5 hours in a constant temperature bath of 60° C.to perform graft polymerization of St-TMIm with the ETFE main chain (a grafting degree of 55%).

The obtained graft membrane was immersed in a dioxane solution of propyl iodide (a concentration of 1M) and reacted for 24 hours in a constant temperature bath of 90° C. The obtained graft membrane was washed in acetone and then immersed in a mixed solution of a 1M-hydrochloric acid aqueous solution and 1,4-dioxane (50/50 vol %) to convert the counter ion to a chloride ion, and then washed with deionized water and dried in vacuum to obtain the resin composition having the chloride ion as a counter anion with a reaction yield of N-alkylation of 100%.

By an operation similar to that in Example 1-1, the obtained resin composition was converted to the anion conductive electrolyte membrane having the hydroxide ion as a counter ion.

The structure of the resin composition in Example 1-2 is indicated in the following formula (7).

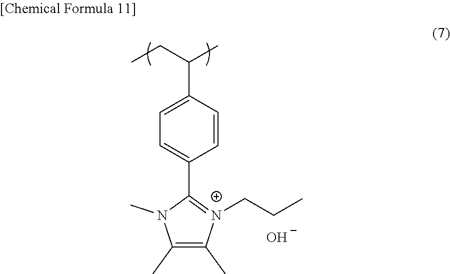

### Comparative Example 1-1

An EFTE membrane with a film thickness of 25 μm (manufactured by DuPont Co.) was irradiated with y rays of 50 kGy under an argon atmosphere at room temperature, and then immersed in the degassed chloromethylstyrene (CMS)/xylene solution (CMS:xylene=1:1) for 2 hours in a constant temperature bath of 60° C.to perform graft polymerization of CMS with the ETFE main chain (a grafting degree of 70%).

The obtained graft membrane was immersed in a trimethylamine aqueous solution (a concentration of 30 wt %) and reacted for 16 hours at room temperature. The obtained graft membrane was washed by deionized water and then immersed in 1M-hydrochloric acid for 24 hours, and then immersed in deionized water and washed for 2 hours to obtain the resin composition having the chloride ion as a counter ion with a reaction yield of quaternization of 100%. A part of the obtained resin composition was freeze-pulverized and used as a binder material for forming the electrode catalyst layer.

By an operation similar to that in Example 1-1, the obtained resin composition was converted to the anion conductive electrolyte membrane having the hydroxide ion as a counter ion.

The structure of the resin composition in Comparative Example 1-1 is indicated in the following formula (8).

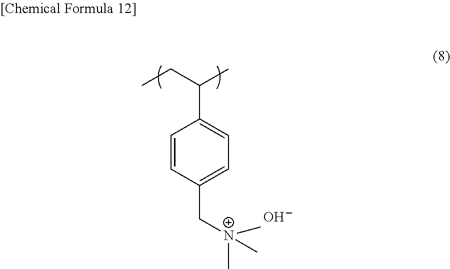

### Comparative Example 1-2

An EFTE membrane with a film thickness of 25 μm (manufactured by DuPont Co.) was irradiated with y rays of 50 kGy under an argon atmosphere at room temperature, and then immersed in the degassed chloromethylstyrene (CMS)/xylene solution (CMS:xylene=1:1) for 2 hours in a constant temperature bath of 60° C. to perform graft polymerization of CMS with the ETFE main chain (a grafting degree of 70%).

The obtained graft membrane was immersed in an ethanol solution of 1,2-dimethyl imidazole (a concentration of 2M) and reacted for 4 hours in a constant temperature bath of 60° C. The obtained graft membrane was washed in acetone and then dried in vacuum to obtain the resin composition having the chloride ion as a counter anion with a reaction yield of N-alkylation of 57%.

By an operation similar to that in Example 1-1, the obtained resin composition was converted to the anion conductive electrolyte membrane having the hydroxide ion as a counter ion.

The structure of the resin composition in Comparative Example 1-2 is indicated in the following formula (9).

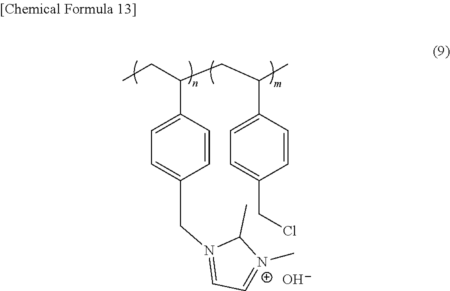

(In the formula, n and m represent the mole ratio)

In Comparative Example 1-2, in the formula (9), n:m=6:4.

### Comparative Example 1-3

An EFTE membrane with a film thickness of 25 μm (manufactured by DuPont Co.) was irradiated with y rays of 50 kGy under an argon atmosphere at room temperature, and then immersed in a degassed 2-(4-ethenylphenyl)—1-methyl-1H-imidazole (St-Im)/1,4-dioxane solution (St-Im:dioxane═1:1) for 5 hours in a constant temperature bath of 60° C.to perform graft polymerization of St-Im with the ETFE main chain (a grafting degree of 47%).

The obtained graft membrane was immersed in a dioxane solution of propyl iodide (a concentration of 1M) and reacted for 24 hours in a constant temperature bath of 90° C. The obtained graft membrane was washed in acetone and then immersed in the mixed solution of the 1M-hydrochloric acid aqueous solution and 1,4-dioxane (50/50 vol %) to convert the counter ion to a chloride ion, and then washed with deionized water and dried in vacuum to obtain the resin composition having the chloride ion as a counter anion with a reaction yield of N-alkylation of 100%.

By an operation similar to that in Example 1-1, the obtained resin composition was converted to the anion conductive electrolyte membrane having the hydroxide ion as a counter ion.

The structure of the resin composition in Comparative Example 1-3 is indicated in the following formula (10).

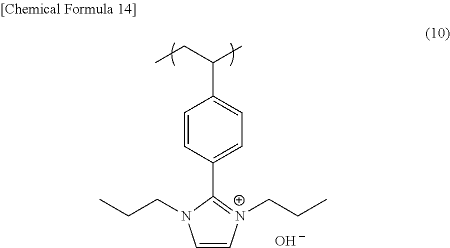

Regarding the anion conductive electrolyte membranes produced in Examples 1-1 and 1-2 and Comparative Examples 1-1 to 1-3, each measurement value related to five evaluation criteria (the grafting degree, an ion exchange capacity (IEC), a water uptake, an ionic conductivity, an alkaline resistance) was determined, and performance evaluations of each anion conductive electrolyte membrane were performed.

It is originally preferable to perform evaluation of such anion conductive electrolyte membrane by using all hydroxide ions as a counter ion. However, the hydroxide ion as a counter ion quickly reacts with carbon dioxide in the atmosphere and turns into a bicarbonate ion. Accordingly, in order to obtain stable measurement values, washing performed after immersion in a basic solution and measurement of the ionic conductivity are performed under deionized water in which carbonic acid has been removed by nitrogen bubbling.

Each measurement value was determined as follows.

(1) Grafting Degree (%)

When a polymer substrate is regarded as a main chain portion and a part subject to graft polymerization with the starting raw material is regarded as a graft chain portion, a weight ratio of the graft chain portion to the main chain portion is represented by a grafting degree of the following formula (X_{dg}[weight %]).

$$\begin{matrix}{X}_{dg} = 100 ( {W}_{2} - {W}_{1} ) / {W}_{1} \\ {W}_{1} : weight in dry state before graft ( g ) \\ {W}_{2} : weight in dry state after graft ( g )\end{matrix}$$

(2) Ion Exchange Capacity (mmol/g)

The ion exchange capacity (Ion Exchange Capacity, IEC) of the anion conductive electrolyte membrane is represented by the following formula.

$$IEC = [ {n ( basic group )}_{obs} ] / {W}_{3} ( mM / g )$$

$$[ {n ( basic group )}_{obs} ] : basic group amount of anion conductive electrolyte membrane ( mM )$$

$${W}_{3} : dry weight of anion conductive electrolyte membrane ( g )$$

The measurement of [n (basic group)_{obs}] is performed in the following procedure.

After the anion conductive electrolyte membrane as hydroxide (hereinafter referred to as “OH type”) is immersed in 0.1M-hydrochloric acid solution, whose capacity is exactly measured, at room temperature for 12 hours, and converted completely into chloride (hereinafter referred to as “Cl type”), the basic group concentration of the anion conductive electrolyte membrane is determined by back-titrating the concentration of the remaining hydrochloric acid solution with 0.1M-NaOH.

(3) Water uptake (%)

After the anion conductive electrolyte membrane of Cl type or OH type preserved in water at room temperature is taken out, and water on its surface is lightly wiped off, the weight (W5 (g)) of it is measured. This membrane is dried in a vacuum at a temperature of 40° C. for 16 hours, and then the dry weight W4 (g) of the anion conductive electrolyte membrane is determined by performing weight measurement to calculate the water uptake from Ws and W4 by the following formula.

$$water uptake = 100 ( {W}_{5} - {W}_{4} ) / {W}_{4}$$

(4) Ionic Conductivity (S/cm)

For measurement by an alternating current method, a membrane resistance measuring cell made of a platinum electrode and LCR meter 3522 manufactured by HIOKI Co. were used. The anion conductive electrolyte membrane in a saturated and swelling state in water at room temperature was taken out and held between the platinum electrodes to measure membrane resistance (Rm) by impedance after being immersed in deionized water at 60° C. for two minutes. Then, the ionic conductivity (standard) of the anion conductive electrolyte membrane was calculated by using the following formula.

$$κ = 1 / Rm \cdot d / S$$

$$\begin{matrix}κ : ionic conductivity of anion conductive electrolyte membrane ( S / cm ) \\ d : thickness of anion conductive electrolyte membrane ( cm ) \\ S : conducting area of anion conductive electrolyte membrane ( {cm}^{2} )\end{matrix}$$

The ionic conductivity of the resin composition (the anion conductive electrolyte membrane) in the embodiment of the present invention is usually 40 mS/cm or more, preferably 50 mS/cm or more. Since the ionic conductivity of the resin composition is within this range, the resin composition can particularly have sufficient practical use as an anion conductive electrolyte membrane.

(5) Alkaline Durability (maintenance factor (%) of the ionic conductivity after immersion in alkaline solution for 200 hours)

Each anion conductive electrolyte membrane was immersed in 1M-KOH heated to 80° C. for 200 hours, and then the ionic conductivity of the anion conductive electrolyte membrane after immersion was determined. Then, the maintenance factor (survival rate) of the ionic conductivity was calculated by using the following formula to evaluate the alkaline durability.

$$maintenance factor = ionic conductivity ( after immersion for 200 hours ) / ionic conductivity ( as prepared ) \times 100$$

The maintenance factor of the ionic conductivity related to the alkaline durability of the resin composition (the anion conductive electrolyte membrane) in the embodiment of the present invention is usually 60% or more, preferably 70% or more. Since the maintenance factor of the ionic conductivity of the resin composition is within this range, in particular, the resin composition can have sufficient practical use as an anion conductive electrolyte membrane.

Table 1 indicates the grafting degree, IEC, the water uptake, the ionic conductivity, the maintenance factor of the ionic conductivity after immersion in 1M-KOH heated to 80° C. for 200 hours of the anion conductive electrolyte membrane produced in Examples 1-1 and 1-2, and Comparative Examples 1-1 to 1-3.

| | | | | | MAINTENANCE FACTOR OF |
|---|---|---|---|---|---|
| | GRAFTING | | WATER | IONIC | IONIC CONDUCTIVITY |
| | DEGREE | IEC | UPTAKE | CONDUCTIVITY | AFTER 200 HOURS |
| | % | meq/g | % | mS/cm | % |
| EXAMPLE 1-1 | 77 | 1.73 | 103 | 152 | 95 |
| EXAMPLE 1-2 | 55 | 1.52 | 49 | 43 | 74 |
| COMPARATIVE EXAMPLE 1-1 | 70 | 2.16 | 119 | 89 | (GELATION) |
| COMPARATIVE EXAMPLE 1-2 | 52 | 1.17 | 53 | 102 | 1 |
| COMPARATIVE EXAMPLE 1-3 | 47 | 1.12 | 38 | 100 | 23 |

From the results in Table 1, it can be confirmed that all of the resin composition (the anion conductive electrolyte membrane) produced in Examples 1-1 and 1-2 has good electrical conductivity, water-containing property, and alkaline durability.

In particular, regarding the maintenance factor (%) of the ionic conductivity after immersion in the alkaline solution for 200 hours related to evaluation of the alkaline durability, in the resin composition using a trimethylammonium salt as an ion conductive group in Comparative Example 1-1, the membrane gelled after 48 hours of immersion. It can be seen that while the maintenance factor of the ionic conductivity of the resin composition where the 4th and 5th positions are not protected in Comparative Example 1-2 was 1%, in the resin composition where the 4th and 5th positions in the ion conductive group (Im) are protected with methyl group of the Example 1-1, which is the resin composition of the present invention, the maintenance factor of the ionic conductivity has been significantly improved to 95%. Similarly, it can be seen that in a comparison between Comparative Example 1-3 and Example 1-2, the maintenance factor of the ionic conductivity has been improved by about three times from 23% to 74%.

Accordingly, from the results of Table 1, it is indicated that the resin composition in the embodiment of the present invention has functions related to the ion conductivity and the alkaline resistance and exhibits sufficient practical use particularly as an anion conductive electrolyte membrane.

### Electrochemical Device

As an example and a comparative example related to the electrochemical device in the embodiment of the present invention, a membrane electrode assembly and a fuel cell were manufactured.

### Example 2

### [1] Preparation of Catalyst Ink for Fuel Side Electrode

A paste where a platinum-ruthenium-carbon catalyst (a ruthenium amount 30 wt %, a platinum amount 23 wt %) and carbon black (VULCAN (registered trademark) XC-72R) were dispersed in distilled water and the resin composition of Example 1-1 dispersed in isopropanol were mixed such that a mixing ratio of platinum:carbon:binder becomes 1.00:2.50:1.04, and then it was dispersed by using ultrasonic wave for 60 minutes at a temperature of 10° C.to prepare a catalyst ink for the fuel side electrode.

### [2] Preparation of Catalyst Ink For Oxygen Side Electrode

A paste where a platinum-carbon catalyst (a platinum amount 46 wt %) and carbon black (VULCAN (registered trademark) XC-72R) were dispersed in distilled water and the resin composition of Example 1-1 dispersed in isopropanol were mixed such that a mixing ratio of platinum:carbon:binder becomes 1.00:1.20:0.55, and then it was dispersed by using ultrasonic wave for 60 minutes at a temperature of 10° C. to prepare a catalyst ink for the oxygen side electrode.

[3] Application and Drying of Each Catalyst Ink

The catalyst ink for the fuel side electrode and the catalyst ink for the oxygen side electrode were each applied to a gas diffusion layer (SIGRACET (registered trademark) 25BC) by a spray method. Subsequently, by drying at a temperature of 25° C., the fuel side electrode having a catalytic area of 5 cm² and a thickness of 150 μm and the oxygen side electrode having a catalytic area of 5 cm² and a thickness of 150 μm were formed.

Here, the gas diffusion layers correspond to the above-described fuel side diffusion layer 8 and oxygen side diffusion layer 9, and the fuel side electrode and the oxygen side electrode in this example are formed on the fuel side diffusion layer 8 and the oxygen side diffusion layer 9 and become ones that are integrated.

### [4] Joining of Fuel Side Electrode, Oxygen Side Electrode, and Electrolyte Membrane (Manufacturing of Membrane Electrode Assembly)

The manufactured fuel side electrode and oxygen side electrode, and the resin composition (the anion conductive electrolyte membrane) of Example 1-1 were each immersed in a 1M-KOH aqueous solution for 1 hour using different containers, and then excess KOH aqueous solution on their surface was wiped off, and then the fuel side electrode, the electrolyte membrane (the anion conductive electrolyte membrane), and the oxygen side electrode were stacked on the fuel cell in this order to join them by tightening assembly bolts of the fuel cell to a torque of 8 Nm.

### [5] Manufacturing of Fuel Cell

The fuel supply member and the air supply member were disposed to the obtained membrane electrode assembly to form a single cell unit fuel cell having the structure illustrated in FIG. 1.

### Comparative Example 2

A membrane electrode assembly and a fuel cell were obtained similarly to Example 2, except that instead of using the resin composition of Example 1-1, the resin composition of Comparative Example 1-1 was mixed in the preparation of the catalyst ink for the fuel side electrode and the catalyst ink for the oxygen side electrode.

The single cell unit fuel cells obtained in Example 2 and Comparative Example 2 were used to perform evaluation related to the output power and durability.

### (1) Fuel Cell Output Power Test

An output power test was performed by using the single cell unit fuel cells obtained in Example 2 and Comparative Example 2.

The fuel-cell cell temperatures were set at 60° C., and in Example 2, hydrogen gas at 50° C.was supplied to the anode side at a rate of 500 ml/min, and oxygen at 51° C. was supplied to the cathode side at a rate of 500 ml/min. to generate electricity. On the other hand, in Comparative Example 2, hydrogen gas at 58° C. was supplied to the anode side at a rate of 500 ml/min., and oxygen at 59° C. was supplied to the cathode side at a rate of 500 ml/min. to generate electricity.

The voltage was measured when the current density was gradually increased from 0 mA/cm², and the output power density at each current was calculated from the obtained values.

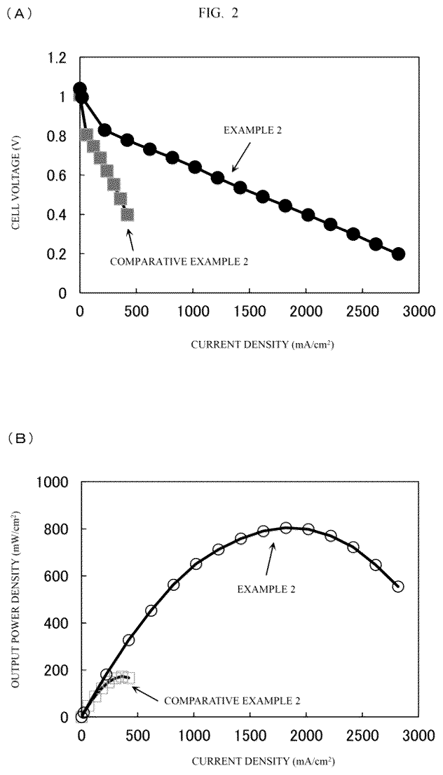

FIG. 2 includes graphs of the measurement results obtained in the performance test. FIG. 2A illustrates a graph of current density-voltage, and FIG. 2B illustrates a graph of current density-output power density.

As illustrated in FIG. 2, while in the fuel cell of Comparative Example 2 in which the resin composition of Comparative Example 1-1 was used as the binder for forming the electrode catalyst layer of the membrane electrode assembly, the maximum output power density was 172 mW/cm², in the fuel cell of Example 2 in which the resin composition of Example 1-1 was used as the binder for forming the electrode catalyst layer of the membrane electrode assembly, the maximum output power density was 804 mW/cm².

Accordingly, it can be seen that power generation performance of the fuel cell of Example 2 in which the resin composition of Example 1-1 was used as a material for the electrolyte layer (the electrolyte membrane) and the electrode in the electrochemical device (the fuel cell) has been approximately 5 times improved compared to the power generation performance of the fuel cell of Comparative Example 2 in which the resin composition of Comparative Example 1-1 was used as a material for the electrolyte layer and the electrode.

It was found that as in Example 2, using the resin composition in the embodiment of the present invention for both the electrolyte layer (the electrolyte membrane) and the binder for forming the electrode catalyst layer to match the compositions of the electrolyte membrane and the binder for forming the electrode catalyst layer was important to improve the power generation performance of the electrochemical device (the fuel cell) from the viewpoint of compatibility and the like.

### (2) Fuel Cell Durability Test

A durability test was performed using the single cell unit fuel cell obtained in Example 2 and Comparative Example 2.

The fuel-cell cell temperatures were set at 60° C., and in Example 2, hydrogen gas at 50° C.was supplied to the anode side at a rate of 100 ml/min., and oxygen at 51° C. was supplied to the cathode side at a rate of 100 ml/min. to generate electricity, and the voltage when the current density was fixed at 50 mA/cm² was measured to calculate a voltage drop rate. On the other hand, in Comparative Example 2, hydrogen gas at 58° C. was supplied to the anode side at a rate of 100 ml/min., and oxygen at 59° C. was supplied to the cathode side at a rate of 100 ml/min. to generate electricity, and the voltage when the current density was fixed at 50 mA/cm² was measured to calculate the voltage drop rate.

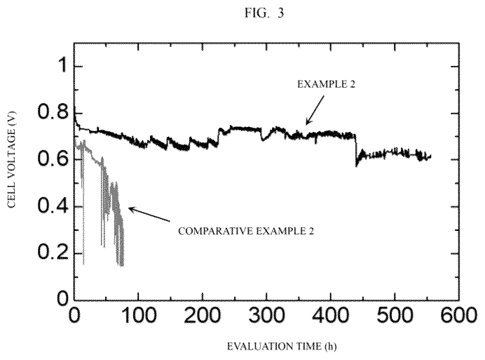

FIG. 3 is a graph illustrating the measurement results obtained in the durability test. FIG. 3 illustrates a temporal change in voltage (a graph of evaluation time-voltage) at a constant current value.

As illustrated in FIG. 3, it was indicated that while in the fuel cell of Comparative Example 2, a cell voltage decreased as evaluation time increased, in the fuel cell of Example 2, the cell voltage of 95% of an initial voltage was able to be maintained even after 440 hours.

The above-described embodiment indicates one example of the resin composition, the resin composition production method, and the electrochemical device. The resin composition, the resin composition production method, and the electrochemical device according to the present invention are not limited to the above-described embodiment, the resin composition, the resin composition production method, and the electrochemical device according to the above-described embodiment may be modified within the scope of not changing the gist stated in the claim.

While in the above-described embodiment, as the resin composition and the resin composition production method of the present invention, the use as a material for the electrolyte layer (the electrolyte membrane) and the electrode (the binder for forming the electrode catalyst layer) in the electrochemical device and the production method for the material has mainly described, it is not limited thereto. For example, the resin composition and the resin composition production method in the present invention can be utilized as materials and production methods for the materials in various fields by taking advantage of their high ion conductivity and high alkaline resistance. For example, the resin composition in the present invention may be utilized in an ion exchange membrane, a reverse osmosis membrane, and the like.

While, in the above-described embodiment, the fuel cell was mainly described as the electrochemical device of the present invention, it is not limited thereto. For example, it is only necessary that the electrochemical device of the present invention is one that can use the resin composition having high ion conductivity and high alkaline resistance as materials for the electrolyte layer (the electrolyte membrane) and the electrode (including the binding material for the catalyst and the active material), and the electrochemical device of the present invention can be applied to other electrochemical devices such as a metal-air battery and a electrolytic bath. In the metal-air battery, the fuel side electrode 6 in the electrochemical device indicated in the embodiment is replaced with an active material such as zinc, aluminum, magnesium, or lithium.

### INDUSTRIAL APPLICABILITY

The resin composition and the resin composition production method of the present invention are ones that are used as a resin composition where functions related to the ion conductivity and the alkaline resistance are imparted and a production method thereof.

The electrochemical device of the present invention is used as an electrochemical device including an electrolyte layer and an electrode. In particular, the electrochemical device is suitably used as a fuel cell or a metal-air battery.

### DESCRIPTION OF REFERENCE SIGNS

1 Electrochemical device, 2 Membrane electrode assembly, 3 Fuel supply member, 4 Air supply member, 5 Electrolyte membrane (electrolyte layer), 6 Fuel side electrode, 7 Oxygen side electrode, 8 Fuel side diffusion layer, 9 Oxygen side diffusion layer, 10 Fuel supply passage, 11 Fuel supply port, 12 Fuel discharge port, 13 Air supply passage, 14 Air supply port, 15 Air discharge port

1. A resin composition comprising one or more first repeat unit represented by formula (1) below, 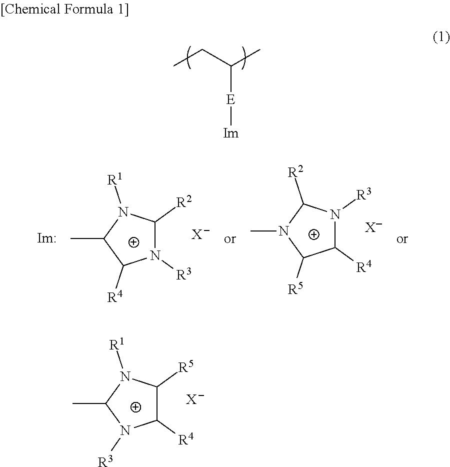
wherein, E is a spacer, and selected from a benzene ring, a benzene derivative in which at least one atom is substituted with a hydrocarbon group having 1 to 6 carbon atoms, or a carbon chain having at least 2 carbon atoms and optionally including a heteroatom, Im is selected from the ion conductive group including an imidazole ring, R¹ to R⁵ each independently represent a carbon chain having 1 to 10 carbon atoms and including hydrogen, halogen or a heteroatom, X⁻ represents an anion).

2. The resin composition according to claim 1, wherein the resin composition further comprising one or more second repeat unit represented by formula (2) below, 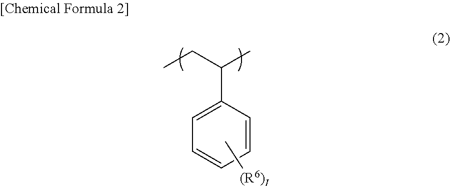
wherein, R⁶ is selected from a carbon chain having 1 to 10 carbon atoms and including hydrogen, halogen or the heteroatom, I represents an integer from 0 to 5).

3. The resin composition according to claim 1, wherein
the repeat unit represented by formula (1), of which imidazole structure of Im is replaced with that of an imidazole ring represented by formula (3) below, 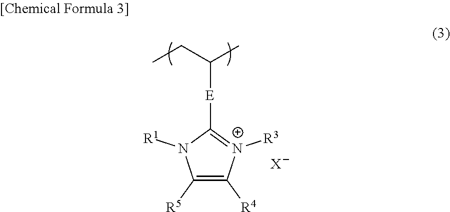
where, E is a spacer, and is selected from a benzene ring, a benzene derivative in which at least one atom is substituted with a hydrocarbon group having 1 to 6 carbon atoms, or a carbon chain having at least 2 carbon atoms and optionally including a heteroatom, at least one of R1 and R3 has 2 or more carbon atoms, R¹, R³, R⁴, R⁵ each independently represent the carbon chains having 1 to 10 carbon atoms and including hydrogen, halogen or the heteroatom, X represents an anion).

4. The resin composition according to claim 2, wherein
the repeat unit represented by formula (1), of which imidazole structure of Im is replaced with that of an imidazole ring represented by formula (3) below, 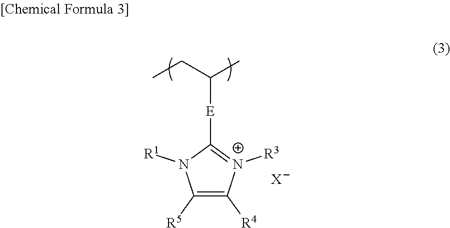
where, E is a spacer, and is selected from a benzene ring, a benzene derivative in which at least one atom is substituted with a hydrocarbon group having 1 to 6 carbon atoms, or a carbon chain having at least 2 carbon atoms and optionally including a heteroatom, at least one of R1 and R3 has 2 or more carbon atoms, R¹, R³, R⁴, R⁵ each independently represent the carbon chains having 1 to 10 carbon atoms and including hydrogen, halogen or the heteroatom, X⁻ represents an anion).

5. The resin composition according to claim 1, wherein the ionic conductivity of the resin composition is 40 mS/cm or more, and the maintenance factor of the ionic conductivity is 70% or more after immersion in 1M-potassium hydroxide aqueous solution heated to 80° C. for 200 hours.

6. The resin composition according to claim 2, wherein
the ionic conductivity of the resin composition is 40 mS/cm or more, and the maintenance factor of the ionic conductivity is 70% or more after immersion in 1M-potassium hydroxide aqueous solution heated to 80° C. for 200 hours.

7. The resin composition according to claim 3, wherein the ionic conductivity of the resin composition is 40 mS/cm or more, and the maintenance factor of the ionic conductivity is 70% or more after immersion in 1M-potassium hydroxide aqueous solution heated to 80° C. for 200 hours.

8. The resin composition according to claim 4, wherein the ionic conductivity of the resin composition is 40 mS/cm or more, and the maintenance factor of the ionic conductivity is 70% or more after immersion in 1M-potassium hydroxide aqueous solution heated to 80° C. for 200 hours.

9. A production method of a resin composition comprising one or more repeat unit represented by the following formula (1), comprising the step of introducing a spacer (E) and/or an ion conductive group (Im) in the following formula (1) by the radiation graft polymerization, 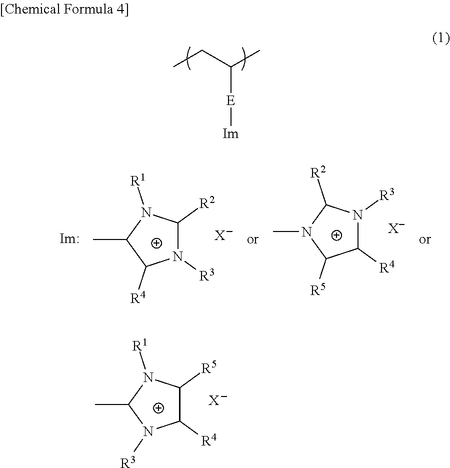
where, E is a spacer, and is selected from a benzene ring, a benzene derivative in which at least one atom is substituted with a hydrocarbon group having 1 to 6 carbon atoms, or a carbon chain having at least 2 carbon atoms and optionally including a heteroatom, Im is selected from the ion conductive group consisting of an imidazole ring, R¹ to R⁵ each independently represent a carbon chain having 1 to 10 carbon atoms and including hydrogen, halogen or a heteroatom, X⁻ represents an anion).

10. An electrochemical device comprising:
an electrolyte layer; and
a pair of electrodes between which the electrolyte layer sandwiched,
wherein the electrolyte layer and/or the electrode are made using the resin composition according to claim 1.

11. An electrochemical device comprising:
an electrolyte layer; and
a pair of electrodes between which the electrolyte layer sandwiched,
wherein the electrolyte layer and/or the electrode are made using the resin composition according to claim 2.

12. An electrochemical device comprising:
an electrolyte layer; and
a pair of electrodes between which the electrolyte layer sandwiched,
wherein the electrolyte layer and/or the electrode are made using the resin composition according to claim 3.

13. An electrochemical device comprising:
an electrolyte layer; and
a pair of electrodes between which the electrolyte layer sandwiched,
wherein the electrolyte layer and/or the electrode are made using the resin composition according to claim 4.

14. An electrochemical device comprising:
an electrolyte layer; and
a pair of electrodes between which the electrolyte layer sandwiched,
wherein the electrolyte layer and/or the electrode are made using the resin composition according to claim 5.

15. The electrochemical device according to claim 10, wherein the electrochemical device is a fuel cell or a metal-air battery.

16. The electrochemical device according to claim 11, wherein the electrochemical device is a fuel cell or a metal-air battery.

17. The electrochemical device according to claim 12, wherein the electrochemical device is a fuel cell or a metal-air battery.

18. The electrochemical device according to claim 13, wherein the electrochemical device is a fuel cell or a metal-air battery.

19. The electrochemical device according to claim 14, wherein the electrochemical device is a fuel cell or a metal-air battery.
